(19) United States
(12) Patent Application Publication
(10) Pub. No.: US 2023/0180674 A1
(43) Pub. Date: Jun. 15, 2023

(54) CUP-BASED GROW CONTAINERS

(71) Applicant: Seed Capital Investments, LLC, Phoenix, AZ (US)

(72) Inventor: Ronald Redburn, Phoenix, AZ (US)

(21) Appl. No.: 17/550,876

(22) Filed: Dec. 14, 2021

(51) Int. Cl. A01G 9/029

(52) U.S. Cl. CPC A01G 9/0295

(57) ABSTRACT

Systems, methods, and devices for growing plants may include a first cup having a first lip disposed about a first opening. A ring may have a first channel defined about an inner diameter of the ring and a second channel defined about the inner diameter of the ring. The ring may retain the first lip in the first channel. Soil and plant material may be disposed in the first cup. A second cup may have a second lip disposed about a second opening. The second cup may be disposed over the first cup with the second lip adjacent the first lip. The ring may retain the second lip in the second channel.

### FIELD

The present disclosure relates to plant growing and, in particular, to cup-based containers for growing plants.

### BACKGROUND

Small plants may be planted after growing from a seed or clipping to a viable stage. It may take weeks to grow a viable plant from a seed or for a clone plant to sufficiently root. During the grow time between seed and viability, many plants and growing systems depend on regular maintenance and attention. Furthermore, many growing systems include costly components and involve time-consuming setup.

### SUMMARY

Systems, methods, and devices for growing plants may include a first cup having a first lip disposed about a first opening. A ring may have a first channel defined about an inner diameter of the ring and a second channel defined about the inner diameter of the ring. The ring may retain the first lip in the first channel. Soil and plant material may be disposed in the first cup. A second cup may have a second lip disposed about a second opening. The second cup may be disposed over the first cup with the second lip adjacent the first lip. The ring may retain the second lip in the second channel.

In various embodiments, the first cup may include a first base with openings formed through the first base. The second cup may include a second base with openings formed through the second base. The first base may comprise circular openings with centers on a circle having a radius between 1.24 and 1.26 inches. A tray may include a plurality of retention cups configured to receive the first cup or the second cup. The inner diameter of the ring may comprise a diameter between 3.8 and 3.9 inches. An assembly guide may be configured to retain the first cup in a stable position in response to the ring snapping over the first lip and the second cup snapping into the ring. The assembly guide may comprise a cylindrical or hourglass geometry.

In various embodiments, the system may comprise a ring having an annular geometry with an inner diameter of the ring comprising a diameter between 3.5 and 4 inches. A first channel may be defined in the inner diameter of the ring. The first channel may be contoured to receive a first lip of a first cup. A second channel may be defined in the inner diameter of the ring and disposed adjacent the first channel. The second channel may be contoured to receive a second lip of a second cup.

In various embodiments, an assembly guide may be configured to retain the first cup in a stable position in response to the ring snapping over the first lip and in response to the second lip of the second cup snapping into the ring. The assembly guide may have a cylindrical or hourglass geometry. The first cup may have a base with openings formed through the base. The second cup may have a base with openings formed through the base. The openings in the base may include circular openings having centers on a circle having a radius between 1.24 and 1.26 inches. The first cup and the second cup may be disposable plastic cups having the same dimensions. The inner diameter of the ring may include a diameter between 3.8 and 3.9 inches. The first channel may have a radial contour with a radius between 0.03 and 0.07 inches. The ring may include a radial thickness between 0.025 and 0.035 inches.

In various embodiments, a method of growing a plant may include placing a first cup into an assembly guide with a first lip of the first cup protruding from the assembly guide. A ring may be pressed onto the first lip of the first cup. The first lip may be retained in a first channel formed about an inner diameter of the ring. A second lip of a second cup may be pressed into the ring. The second lip may be retained in a second channel formed about the inner diameter of the ring.

In various embodiments, the assembly guide may be configured to retain the first cup in a stable position in response to pressing the ring onto the first lip and pressing the second lip into the ring. The assembly guide comprises at least one of a cylindrical or hourglass geometry. An opening may be formed through a first base of the first cup, and an opening may be formed through a second base of the second cup.

### BRIEF DESCRIPTION

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

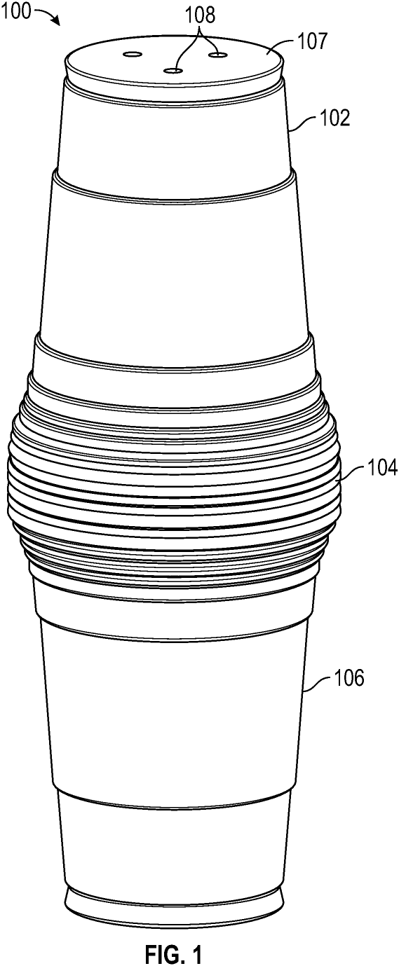

FIG. 1 illustrates a perspective view of two cups coupled together by a ring to function as a grow container, in accordance with various embodiments;

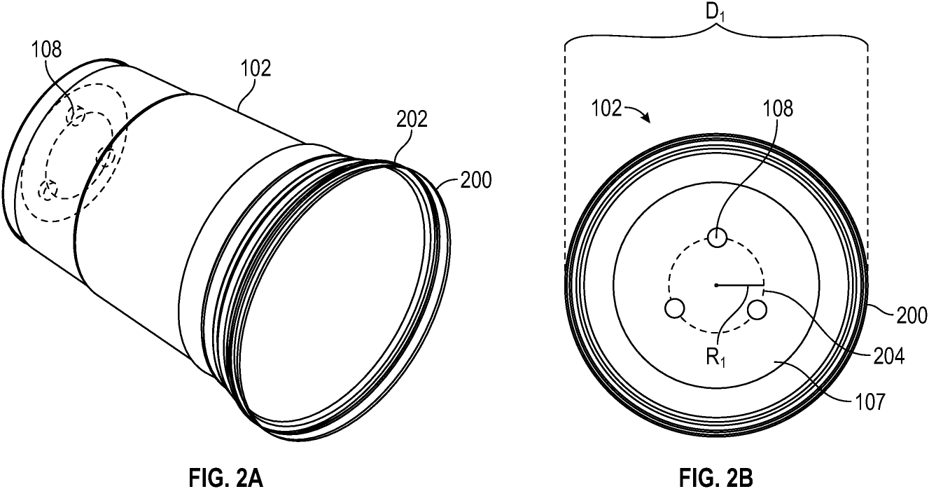

FIG. 2A illustrates a perspective view of a cup having openings formed through its base, in accordance with various embodiments;

FIG. 2B illustrates a top view of a cup having openings formed through its base, in accordance with various embodiments;

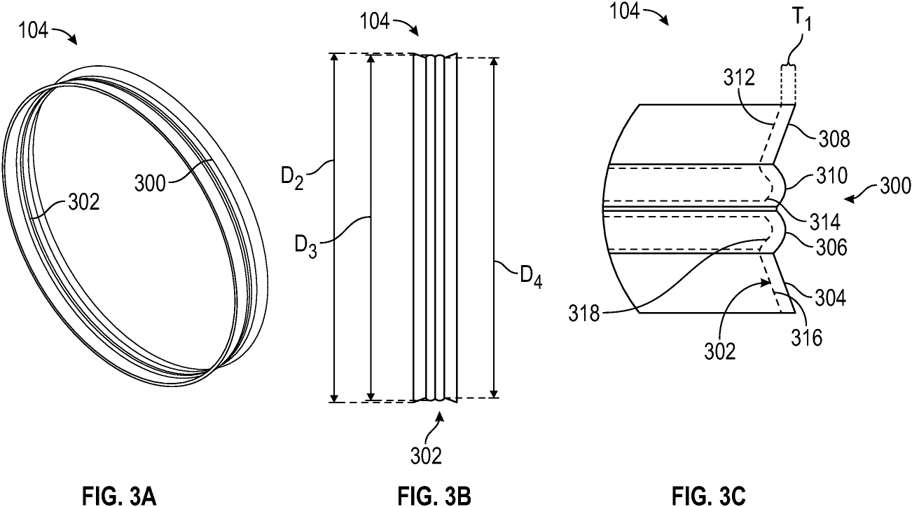

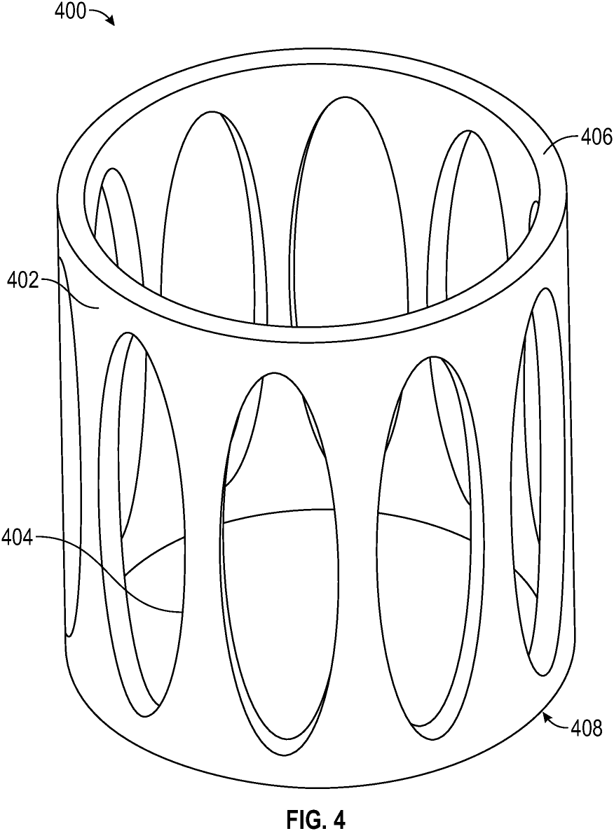

FIG. 3A illustrates a perspective view of a ring for coupling two cups together, in accordance with various embodiments;

FIG. 3B illustrates an elevation view of a ring for coupling two cups together, in accordance with various embodiments;

FIG. 3C illustrates a detail view of a ring for coupling two cups together, in accordance with various embodiments;

FIG. 4 illustrates a perspective view of an assembly guide for coupling two cups together, in accordance with various embodiments;

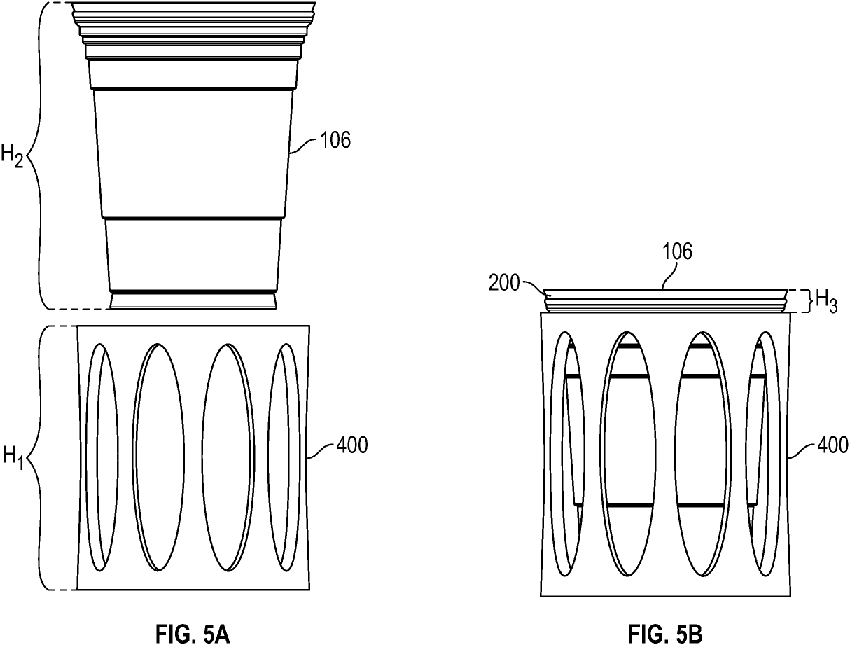

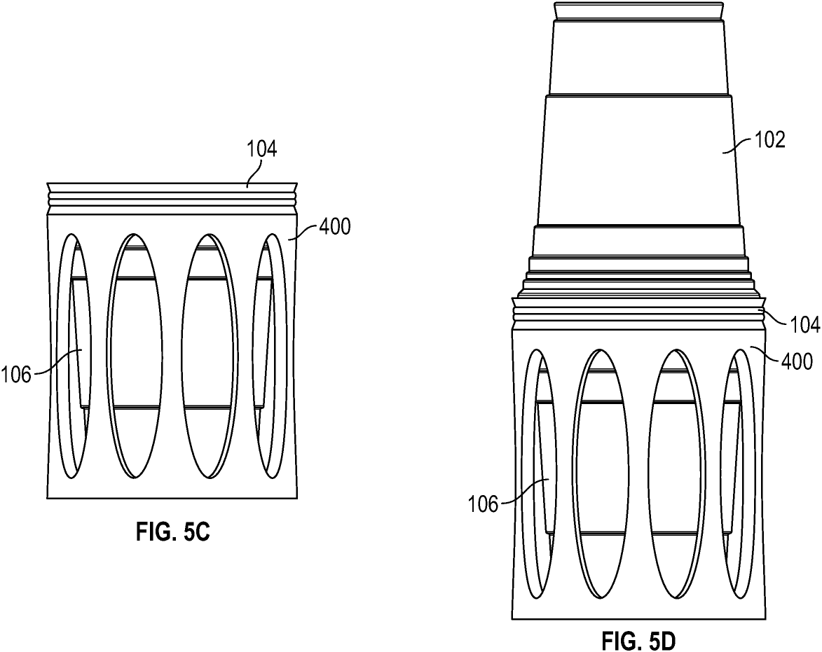

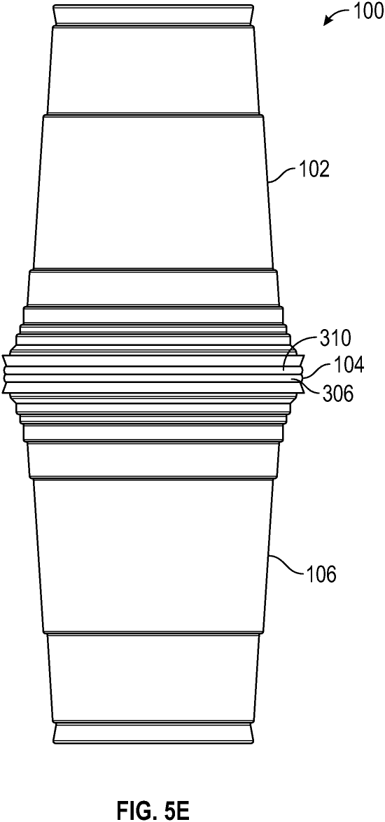

FIG. 5A illustrates a cup disposed over an assembly guide, in accordance with various embodiments;

FIG. 5B illustrates a cup inserted into an assembly guide with a lip of the cup protruding from the assembly guide, in accordance with various embodiments;

FIG. 5C illustrates a coupling ring disposed on an assembly guide and disposed on a lip of a cup, in accordance with various embodiments;

FIG. 5D illustrates two cups coupled together by a ring protruding from an assembly guide, in accordance with various embodiments;

FIG. 5E illustrates an elevation view of two cups coupled together by a ring, in accordance with various embodiments;

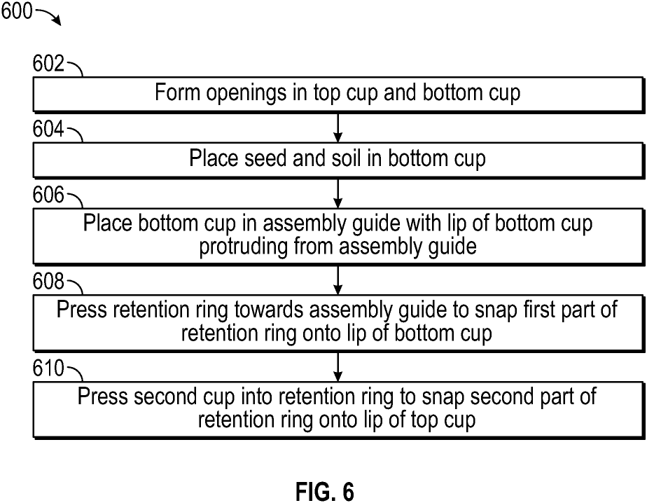

FIG. 6 illustrates a method for coupling two cups using a ring, in accordance with various embodiments;

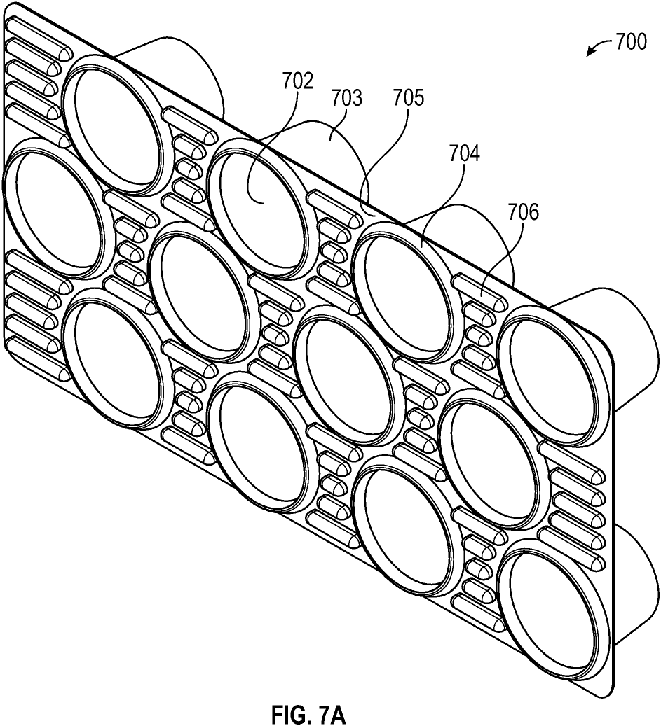

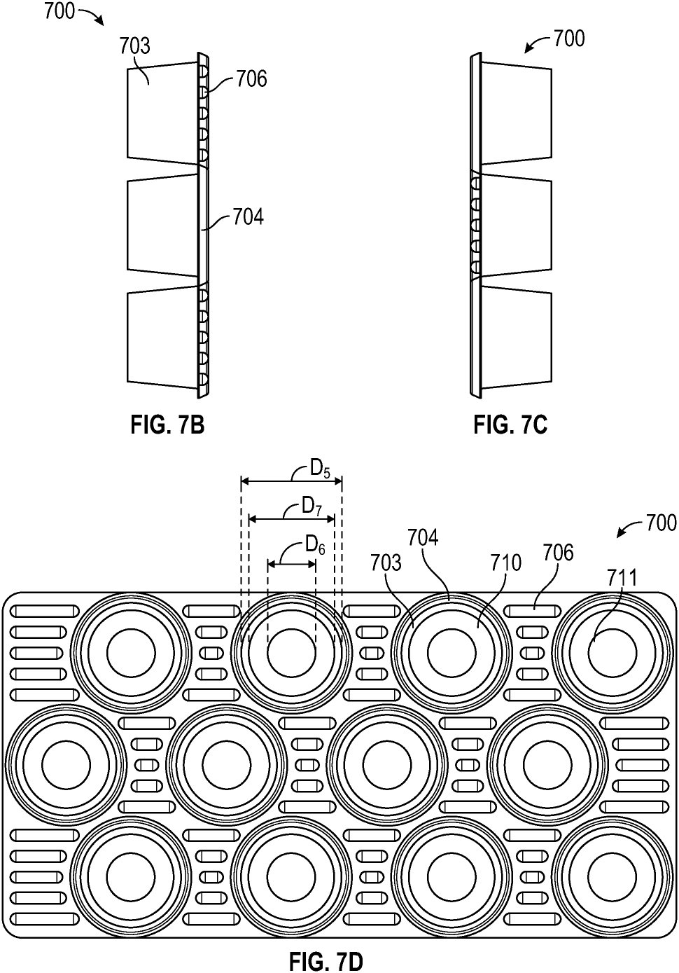

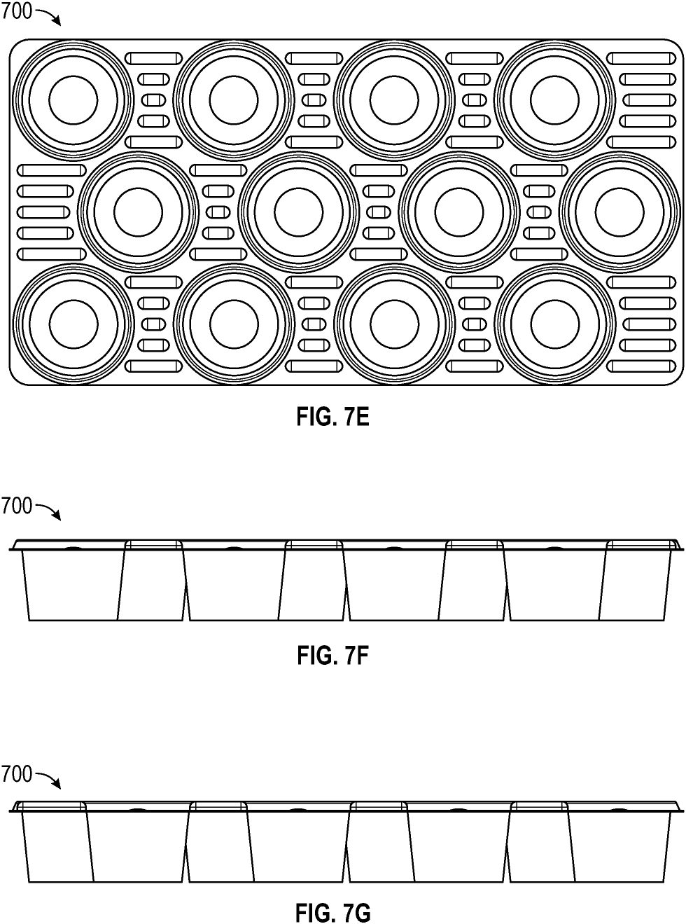

FIG. 7A illustrates a perspective view of a tray for storing growing systems, in accordance with various embodiments;

FIG. 7B illustrates a first side elevation view of a tray for storing growing systems, in accordance with various embodiments;

FIG. 7C illustrates a second side elevation view of a tray for storing growing systems, in accordance with various embodiments;

FIG. 7D illustrates a top view of a tray for storing growing systems, in accordance with various embodiments;

FIG. 7E illustrates a bottom view of a tray for storing growing systems, in accordance with various embodiments;

FIG. 7F illustrates a third side elevation view of a tray for storing growing systems, in accordance with various embodiments; and

FIG. 7G illustrates a fourth side elevation view of a tray for storing growing systems, in accordance with various embodiments.

### DETAILED DESCRIPTION

The detailed description of exemplary embodiments herein refers to the accompanying drawings, which show exemplary embodiments by way of illustration. While these exemplary embodiments are described in sufficient detail to enable those skilled in the art to practice the inventions, other embodiments may be realized, and that logical, chemical, and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

The present disclosure is directed to a system for growing plants. Two cups may be coupled together to define a volume suitable for growing plants at various stages. The cups may be plastic, disposable cups coupled together by a ring, though other materials and cups are suitable in various embodiments. In that regard, the present disclosure is directed to systems, methods, and devices for growing plants in a low-cost terrarium.

Referring to FIG. 1, a system 100 is shown for growing plants, in accordance with various embodiments. System 100 may include cup 102 disposed over cup 106. Ring 104 may couple cup 102 and cup 106 by retaining the lips of cup 106 and cup 102. The inner diameter of ring 104 may define retention channels to retain the lips of cup 102 and cup 106. Ring 104 may be formed integrally with or permanently coupled to cup 106 or cup 102. Ring 104 may be removable coupled to cup 106 or cup 102. Cup 106 and cup 102 may define an interior volume suitable for growing a seedling or clone.

In various embodiments, bottom cup 106 may contain soil, plant material (e.g., a seed, seedling, or clone), and water. Bottom cup 106 may function as a clone cup. Top cup 106 may contain air and receive plant growth that extends above the lip of bottom cup 102. Top cup 102 may function as a humidity dome. Top cup 106 may govern the rate of water evaporation from the volume between bottom cup 106 and top cup 102 based at least in part on openings 108 formed in top cup 102 to meter ventilation. Bottom cup may govern the rate of water drainage based at least in part on drainage openings formed in bottom cup 106. Drainage openings may be the same as or similar to openings 108 formed through base 107. System 100 may function as a terrarium during growth of a seedling or small clone.

In various embodiments, system 100 may serve as a growth container in response to a seedling or clipping reaching a viable stage of growth. Top cup 102 may be removed from system 100 to expose the contents of bottom cup 106 directly to environmental conditions outside system 100. For example, top cup 102 may be removed from system after 3 weeks of growth to expose a seedling to light and increase the rate of evaporation. A seedling or clone may continue to grow in bottom cup 106 without top cup 102 in response to exposure to conditions outside system 100.

With reference to FIGS. 2A and 2B, cup 102 of system 100 (of FIG. 1) is shown, in accordance with various embodiments. Cup 106 may be the same as or similar to cup 102. Cup 102 may comprise lip 200 having an outer contour 202. Outer contour 202 may generally taper outwards when moving along cup from base 107 to lip 200. In that regard, the diameter of cup 102 may tend to be smaller nearer base 107 and larger nearer lip 200. Cup 102 may have a maximum diameter D₁ along outer contour 202 near lip 200. Diameter D₁ may be about 3.8 inches, for example. In additional examples, diameter D₁ may be within a range of 3.7 inches to 3.9 inches, 3.6 inches to 4.0 inches, or 3.5 inches to 4.1 inches.

In various embodiments, openings 108 may be formed through base 107 of cup 106. Openings 108 may be formed through multiple cups at once by drilling through the cups with a drill bit having a predetermined size. Openings 108 may be formed through cups using a punch. Multiple openings 108 may be formed through base 107. For example, one, two, three, four, five, or any other suitable number of openings 108 may be formed through base 107.

In various embodiments, Openings 108 may be disposed on a circle 204 having a radius R₁. Circle 204 may pass through the center of openings 108. Openings may also be placed in other patterns or in irregular patterns on base 107. Openings 108 may be formed to achieve a desired ratio of surface area of cup 106 to opening area of cup 106. Openings 108 may be formed to achieve a desired opening area of cup 106. The desired opening area or ratio of surface area to opening area may be selected to meter evaporation or drainage at a desired rate.

In various embodiments, openings 108 may be circular. Openings 108 may have any shape including, for example, triangular, square, polygonal, semicircular, irregular, or other suitable shapes. Openings 108 may meter evaporation or water vapor retention when formed in a top cup 106. When formed in a bottom cup, openings 108 may meter water drainage from soil retained in the bottom cup.

In various embodiments, openings 108 may have a diameter of about 0.2 inches, 0.25 inches, 0.3 inches, 0.35 inches, or 0.4 inches. As used herein with measurements of distance, area, or volume, the term ‘about’ may mean +/- 5%, +/- 10%, +/- 15%, or +/- 20%. The surface area of each opening 108 may be about 0.03 square inches, 0.04 square inches, 0.05 square inches, 0.08 square inches, or 0.12 square inches, for example.

In various embodiments, cup 102 or cup 106 may be made of plastic, rubber, metal, composite, paper, cardboard, glass, or other suitable cup material. The cups may be plastic disposable cups such as, for example, those offered by the Solo Cup Company under its Solo® brand. Cups may be formed having a lip suitable for retention in a retention ring.

Referring now to FIGS. 3A, 3B, and 3C, ring 104 is shown for coupling two cups together, in accordance with various embodiments. Ring 104 may comprise outer contour 300 and inner contour 302. Ring 104 may have a thickness T₁ that is substantially consistent such that outer contour 300 may follow inner contour 302. Inner contour 302 and outer contour 300 may have similar shapes. Ring 104 may be made from plastic, rubber, composite, paper, cardboard, metal, or any other material suitable for removably coupling two cups. Ring 104 may be durable, reusable, and lightweight. Ring 104 comprising rigid material may tend to increase retention force exerted onto cups retained by ring 104. Ring 104 comprising elastic or malleable materials may also retain cups in ring 104.

In various embodiments, outer contour 300 of ring 104 may comprise guide flange 304, retention band 306, retention band 310, and guide flange 308. Retention band 306 may define a retention channel along inner surface 318. Retention band 310 may define a retention channel along inner surface 314. The retention channels may be defined about an inner diameter of ring 104. The retention channels defined by the retention bands may each retain a retain lip 200 (of FIG. 2A) of a cup having suitable geometry.

In various embodiments, guide flange 308 and guide flange 304 may have frustoconical shapes. Guide flange 304 may funnel or taper toward retention band 306. Inner surface 312 of guide flange 308 may guide lip 200 (of FIG. 2A) of a cup into retention band 310 in response to the cup being pressed into ring 104. Guide flange 308 may funnel or taper toward retention band 310. Inner surface 316 of guide flange 304 may guide lip 200 (of FIG. 2A) of a cup into retention band 306 in response to the cup being pressed into ring 104.

In various embodiments, ring 104 may comprise an outer diameter D₂. Diameter D₂ may be the outer diameter of ring 104 at its widest point. Ring 104 may have an inner diameter D₃ at the widest point of retention band 306 or retention band 310. For example, D₃ may be about 3.87 inches. D₃ may be any radius sufficient to retain lip 200 (of FIG. 2A) of cup 106 (of FIG. 2A). Diameter D₃ may be sized in response to the diameter D₁ (of FIG. 2A) of a selected cup 106 (of FIG. 2A). Diameter D₃ may be in the range from a length larger than diameter D₁ to a length slightly smaller than diameter D₁.

In various embodiments, ring 104 may have an inner diameter D₄ at a narrow point. Ring 104 may have a diameter D₄ adjacent to retention band 310 or retention band 306 sufficiently small to retain a cup in retention band 310 or retention band 306. Diameter D₄ of ring 104 may be less than diameter D₁ (of FIG. 2A) of lip 200 (of FIG. 2A). Diameter D₄ of ring 104 may also less than diameter D₃ of ring 104. The diameters of ring 104 may have a relationship such that D₂ > D₃ > D₄.

Referring now to FIG. 4, assembly guide 400 is shown, in accordance with various embodiments. Assembly guide 400 may include upper end surface 406 having a planar geometry. Assembly guide 400 may be an annulus. The lip of a cup may protrude from upper end surface 406 in response to the base of the cup being fully inserted into assembly guide 400. Assembly guide 400 may include lower end surface 408. Lower end surface 408 may have a planar geometry. Lower end surface 408 may engage a flat surface to provide a platform for assembling system 100 (of FIG. 1). Openings 404 having an elongated or oval geometry may be formed in sidewalls of assembly guide 400. Openings 404 may by polygonal, circular, triangular, semicircular, irregular, or any other shape suitable to maintain sufficient strength to facilitate assembly of system 99. Openings 404 may reduce weight and engage hands during use for enhanced grip.

In FIGS. 5A through 5E, the assembly of system 100 (of FIG. 1) is shown, in accordance with various embodiments. In FIG. 5A, assembly guide 400 having height H₁ may be placed on a flat surface. Cup 106 having height H₂ may be inserted into assembly guide 400. Cup 106 may rest on the same surface as assembly guide 400. Height H₁may be less than height H₂.

Referring to FIG. 5B, cup 106 may protrude a height of H₃ from assembly guide 400, in accordance with various embodiments. Height H₃ may be the difference between height H₁of assembly guide 400 and height H₂ of cup 106. Lip 200 of cup 106 may be exposed from assembly guide 400. Height H₃ may be sufficient for cup 106 to receive a coupling ring over lip 200.

With reference to FIG. 5C, ring 104 may be coupled to cup 106, in accordance with various embodiments. Users may press ring 104 towards assembly guide 400 and onto lip 200 (of FIG. 5B) of cup 106. Lip 200 may deform or ring 104 may deform in response to the compressive force applied in response to pressing ring 104 towards assembly guide 400. Ring 104 may snap onto cup 106. A minimum insertion force may be applied to ring 104 to urge lip 200 into a retention band of ring 104.

Referring now to FIG. 5D, cup 102 may be coupled to ring 104 and cup 106, in accordance with various embodiments. Users may press cup 102 into ring 104 towards cup 106. The lip of cup 102 may snap into a retention band of ring 104 in response to the compressive force applied in pressing cup 102 towards ring 104 and cup 106. A minimum insertion force may be applied to cup 102 to urge lip 200 into a retention band of ring 104. Ring 104 may retain the lips of cup 102 and cup 106 adjacent one another. Ring 104 may apply a retention force to cup 102 or cup 106 in response to a pulling force pulling cup 102 and cup 106 apart. Cups may separate in response to the pulling force overcoming the maximum retention force applied by ring 104 onto the lip of cup 102 or the lip of cup 106. The retention force exerted by ring 104 may be sufficiently strong to retain system 100 in a completely assembled configuration, including water and soil in the bottom cup.

Referring to FIG. 5E, assembled system 100 is shown, in accordance with various embodiments. The lip of cup 102 may be retained in retention band 310. The lip of cup 106 may be retained in retention band 306. Cup 102 and cup 106 may define an interior volume suitable for retaining soil and water to germinate seeds or support clone growth. System 100 may remain intact for two to four weeks with minimal upkeep. Cup 102 may be removed to expose the seedling or clone to surrounding environmental conditions after 2-4 weeks. The seedling or clone may continue to grow in cup 106 with minimal tending for 2-4 additional weeks.

Referring now to FIG. 6, method 600 for growing plants using system 100 (of FIG. 1) is shown, in accordance with various embodiments. Step 602 may include forming openings 108 (of FIG. 1) in the top cup 102 (of FIG. 1) or bottom cup 106 (of FIG. 1). Openings may be formed through multiple stacked cups using a template and drilling with a bit sized to affect the desired size openings. Cups may be molded with openings 108 left by the mold after formation. Openings 108 may be pressed, stamped, or punched into the base of the cups. Openings formed in top cup 102 may meter evaporation of water from system 100. Openings formed in bottom cup 106 may meter drainage of water from system 100.

In various embodiments, plant material (e.g., seed, seedling, or clone clippings) and soil may be placed in bottom cup 106 (of FIG. 1) in Step 604. Water may be added to soil in bottom cup 106. Soil may all or partially fill bottom cup 106. For example, bottom cup 106 may be filled soil reaching a level up to about 1.5 inches, 1 inch, 0.5 inches, 0.25 inches, or 0 inches below lip 200 (of FIG. 2A) of bottom cup 106. Soil may be compressed in cup 106 to remove air pockets.

In various embodiments, bottom cup 106 may be placed in assembly guide 400 (of FIG. 4) with lip 200 (of FIG. 2A) of the cup protruding from assembly guide 400 (Step 606). Assembly guide 400 and base 107 of cup 106 may rest on a flat surface. Cup 106 may contain soil, plant material, and water suitable for germinating a plant when placed in assembly guide 400. Soil, plant material, and water may be added to cup 106 after cup 106 is placed in assembly guide 400.

In various embodiments, ring 104 (of FIG. 1) may be pressed towards mating tool to snap a first portion of retention ring onto lip 200 (Step 608). Ring 104 may couple cup 102 (of FIG. 1) to cup 106 (of FIG. 1). The retention ring or coupling ring may exert sufficient coupling force to maintain the coupling in response to a user lifting system 100 by the top cup. The retention force exerted by ring 104 may thus have a decoupling force greater than the weight of bottom cup 106 along with soil, water, and plant material contained in bottom cup 106. Lip 200 may snap into a retention band of ring 104 defining a retention channel shaped to retain lip 200.

In various embodiments, top cup 102 (of FIG. 1) may be pressed towards mating tool, ring 104, and bottom cup 106 to snap a second portion of retention ring onto lip 200 of top cup 102 (Step 610). Lip 200 may snap into a retention band of ring 104 defining a retention channel shaped to retain lip 200. A minimum engagement force may be applied to cup 102 to snap lip 200 into ring 104.

In various embodiments, system 100 may remain assembled through a germination period. System 100 may remain assembled for 1 week, 2 weeks, 3 weeks, 4 weeks, or 5 weeks, for example. A suitable germination period may be selected in part on the type of plant being grown in system 100. Top cup 102 may be removed from system 100 in response to a predetermined period passing. Top cup 102 may be removed in response to a sufficient root system growing in bottom cup 106. Top cup 102 may be removed in response to a sufficient height of plant material extending into top cup 102. Bottom cup 106 may serve as a continued growth container in response to removal of top cup 102. Continued growth may last 1 week, 2 weeks, 3 weeks, 4 weeks, or 5 weeks, for example. Water or nutrients may be added to bottom cup 106 during the continued growth phase. Continued growth may allow the clone or seedling to further harden before transplanting.

Referring to FIGS. 7A through 7G, a tray 700 is shown for storing or moving growing systems 100 (of FIG. 1), in accordance with various embodiments. Tray 700 may comprise retention cups 702 configured to receive bottom cup 106 (of FIG. 1). Retention cups 702 may be defined by sidewall 703 having a rounded geometry. Sidewall 703 may meet rim 704. Rim 704 may protrude above sheet 705, and sidewall 703 may extend below sheet 705. Sheet 705 may comprise ribs 706 formed in sheet 705. Ribs 706 may be parallel. Ribs 706 may extend along long dimension of sheet 105 to increase stiffness or rigidity.

In various embodiments, cups 702 may comprise sidewall 703 that meets bottom wall 710. Bottom wall 710 may be substantially parallel to sheet 705. Retention cup 702 may have a diameter D₅ along rim 704. Diameter D₅ may approximate a diameter of bottom cup 106 (of FIG. 1). In that regard, cup 106 may fit into retention cup 702 with minimal play or a snug fit.

In various embodiments, retention cup 702 may have a lower diameter D₇ measured along the interior of retention cup 702 at bottom wall 710. Diameter D₇ may approximate the diameter of bottom cup 106 at its base. In that regard, cup 106 may fit into retention cup 702 with minimal play or a snug fit near bottom wall 710. Bottom wall 710 may define an opening 711. Opening 711 may be circular with a diameter D₆ sufficient to expose openings 108 (of FIG. 1) formed in bottom cup 106 (of FIG. 1). Opening 711 may allow for drainage from bottom cup 106.

In various embodiments, retention cups 702 may be spaced 5 inches on center in a staggered arrangement. Tray 700 may comprise 9, 10, 11, 12, 13, 14, 15, or any suitable number of retention cups 702 to retain multiple systems 100 (of FIG. 1). Tray 700 may comprise 2, 3, 4, 5, 6, or any other suitable number of rows of retention cups 702. Tray 700 may be stackable to facilitate storage or transportation of multiple trays 700.

Benefits, other advantages, and solutions to problems have been described herein regarding specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “A, B, or C” is used, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for growing plants, comprising:
a first cup having a first lip disposed about a first opening, wherein the first cup contains soil and plant material disposed in the soil;
a ring having a first channel defined about an inner diameter of the ring and a second channel defined about the inner diameter of the ring, wherein the ring retains the first lip in the first channel; and
a second cup having a second lip disposed about a second opening, wherein the second cup is disposed over the first cup with the second lip adjacent the first lip, wherein the ring retains the second lip in the second channel.

2. The system of claim 1, wherein:
the first cup comprises a first base with a first plurality of openings formed through the first base; and
the second cup comprises a second base with a second plurality of openings formed through the second base.

3. The system of claim 2, wherein the first plurality of openings in the first base comprises circular openings having centers on a circle having a radius between 1.24 and 1.26 inches.

4. The system of claim 2, further comprising a tray including a plurality of retention cups configured to receive at least one of the first cup or the second cup.

5. The system of claim 1, wherein the inner diameter of the ring comprises a diameter between 3.8 and 3.9 inches.

6. The system of claim 1, further comprising an assembly guide configured to retain the first cup in a stable position in response to the ring snapping over the first lip and the second cup snapping into the ring.

7. The system of claim 6, wherein the assembly guide comprises at least one of a cylindrical or hourglass geometry.

8. A system for growing plants, comprising:
a ring having an annular geometry with an inner diameter of the ring comprising a diameter between 3.5 and 4 inches;
a first channel defined in the inner diameter of the ring, wherein the first channel is contoured to receive a first lip of a first cup; and
a second channel defined in the inner diameter of the ring and disposed adjacent the first channel, wherein the second channel is contoured to receive a second lip of a second cup.

9. The system of claim 8, further comprising an assembly guide configured to retain the first cup in a stable position in response to the ring snapping over the first lip and in response to the second lip of the second cup snapping into the ring.

10. The system of claim 9, wherein the assembly guide comprises at least one of a cylindrical or hourglass geometry.

11. The system of claim 8, wherein:
the first cup comprises a first base with a first plurality of openings formed through the first base; and
the second cup comprises a second base with a second plurality of openings formed through the second base.

12. The system of claim 11, wherein the plurality of openings in the first base comprises circular openings having centers on a circle having a radius between 1.24 and 1.26 inches.

13. The system of claim 11, wherein the first cup and the second cup are disposable plastic cups having the same dimensions.

14. The system of claim 11, wherein the inner diameter of the ring comprises a diameter between 3.8 and 3.9 inches.

15. The system of claim 11, wherein the first channel has a radial contour with a radius between 0.03 and 0.07 inches.

16. The system of claim 11, wherein the ring comprises a radial thickness between 0.025 and 0.035 inches.

17. A method of growing a plant, comprising:
placing a first cup into an assembly guide with a first lip if the first cup protruding from the assembly guide;
pressing a ring onto the first lip of the first cup, wherein the first lip is retained in a first channel formed about an inner diameter of the ring; and
pressing a second lip of a second cup into the ring, wherein the second lip is retained in a second channel formed about the inner diameter of the ring.

18. The method of claim 17, wherein the assembly guide is configured to retain the first cup in a stable position in response to pressing the ring onto the first lip and pressing the second lip into the ring.

19. The method of claim 18, wherein the assembly guide comprises at least one of a cylindrical or hourglass geometry.

20. The method of claim 17, further comprising:
forming an opening through a first base of the first cup; and
forming an opening through a second base of the second cup.
